(19) United States
(12) Patent Application Publication
(10) Pub. No.: US 2013/0068703 A1
(43) Pub. Date: Mar. 21, 2013

(54) COLANDER-CONTAINER VESSEL AND METHOD OF USE

(71) Applicants: Hetal Jariwala, Albany, CA (US); Eva Elizabeth Bauer, Albany, CA (US)

(72) Inventors: Hetal Jariwala, Albany, CA (US); Eva Elizabeth Bauer, Albany, CA (US)

(21) Appl. No.: 13/624,560

(22) Filed: Sep. 21, 2012

Related U.S. Application Data
(60) Provisional application No. 61/626,206, filed on Sep. 21, 2011.

(51) Int. Cl. A47J 43/24; B01D 37/00

(52) U.S. Cl. 210/767; 210/469

(57) ABSTRACT

Colander-container vessels are presented including: a bowl, the bowl including, a lip; a sidewall surface, where the sidewall surface includes a number of perforations disposed proximate with a front portion of the lip, and a bottom surface; and a retention surface disposed along the front portion of the lip, where the retention surface extends away and inward from the lip. In some embodiments, colander-container vessels further include a handle disposed along a back portion of the lip. In some embodiments, the retention surface includes a second number of perforations.

### PRIORITY CLAIM TO PROVISIONAL APPLICATION

A claim for priority is hereby made under the provisions of 35 U.S.C. §119 for the present application based upon U.S. Provisional Application No. 61/626,206, filed on Sep. 21, 2011 which is incorporated herein by reference.

### FIELD OF INVENTION

Embodiments provided herein relate to colanders and related methods of use.

### BACKGROUND

Currently, a wide variety of colanders and colander products are available for consumers. Conventional colanders allow a user to rinse food stuffs such as produce, meat, legumes, or grains by placing contents within the colander and then running water over the contents. Conventional colanders have many small perforations over the colander surface so that the running water may quickly drain out. Utilizing a colander in this manner facilitates removal of debris on the food stuffs.

In some instances, however, food stuffs may benefit from cleaning methods not achievable by conventional solutions. For example, repeated soaking and agitation may provide a higher degree of food cleanliness over conventional solutions. As such colander-container vessels and methods of use are provided herein.

### SUMMARY

The following presents a simplified summary of some embodiments of the invention in order to provide a basic understanding of the invention. This summary is not art extensive overview of the invention. It is not intended to identify key/critical elements of the invention or to delineate the scope of the invention. Its sole purpose is to present some embodiments of the invention in a simplified form as a prelude to the more detailed description that is presented below.

As such, colander-container vessels are presented including: a bowl, the bowl including, a lip; a sidewall surface, where the sidewall surface includes a number of perforations disposed proximate with a front portion of the lip, and a bottom surface; and a retention surface disposed along the front portion of the lip, where the retention surface extends away and inward from the lip. In some embodiments, colander-container vessels further include a handle disposed along a back portion of the lip. In some embodiments, the retention surface includes a second number of perforations. In some embodiments, colander-container vessels further include a first base disposed along the bottom surface, where the first base is configured for stabilizing the colander-container vessel on a substantially planar surface in a substantially vertical position. In some embodiments, colander-container vessels further include a second base disposed along the sidewall surface proximate with the handle, where the second base is configured for stabilizing the colander-container vessel on a substantially planar surface in a back-tilted position. In some embodiments, colander-container vessels further include a third base disposed along the sidewall surface proximate with the retention surface, where the third base is configured for stabilizing the colander-container vessel on a substantially planar surface in a forward-tilted position.

In other embodiments, colander-container vessels are presented including: a bowl, the bowl including, a lip, a sidewall surface, and a bottom surface; and a retention surface disposed along the front portion of the lip, where the retention surface extends away and inward from the lip, and where the retention surface includes a number of perforations. In some embodiments, colander-container vessels further the sidewall surface includes a number of perforations disposed proximate with a front portion of the lip. In some embodiments, the perforations form a spherical lune pattern. In some embodiments, colander-container vessels further include a first base disposed along the bottom surface, where the first base is configured for stabilizing the colander-container vessel on a substantially planar surface in a substantially vertical position. In some embodiments, colander-container vessels further include a second base disposed along the sidewall surface proximate with the handle, where the second base is configured for stabilizing the colander-container vessel on a substantially planar surface in a back-tilted position. In some embodiments, colander-container vessels further include a third base disposed along the sidewall surface proximate with the retention surface, where the third base is configured for stabilizing the colander-container vessel on a substantially planar surface in a forward-tilted position.

In other embodiments, methods for utilizing a colander-container vessel are presented including: providing the colander-container vessel, where the colander-container vessel includes, a bowl, the bowl including, a lip, a sidewall surface, where the sidewall surface includes a first number of perforations disposed proximate with a front portion of the lip, and a bottom surface, and a retention surface disposed along the front portion of the lip, wherein the retention surface extends away and inward from the lip; placing the solid food stuff in the colander-container vessel; filling the colander-container vessel with a liquid; soaking the solid food stuff for a user defined period; and straining away the liquid while retaining the solid food stuff in the colander-container vessel. In some embodiments, methods further include agitating the solid food stuff before the straining away the liquid. In some embodiments the liquid is selected from the group consisting of: an aqueous cleaning solution, a non-aqueous cleaning solution, an aqueous soaking solution, a non-aqueous soaking solution, a non-edible solution, and an edible solution. In some embodiments, the solid food stuff is selected from the group consisting of: a vegetable, a fruit, a legume, a grain, an animal product, and a plant product.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative orthogonal representation of a colander-container vessel in accordance with embodiments of the present invention;

FIG. 2 is an illustrative cross-sectional representation of a colander-container vessel in accordance with embodiments of the present invention;

FIG. 3 is an illustrative cross-sectional representation of a colander-container vessel in accordance with embodiments of the present invention;

FIG. 4 is an illustrative cross-sectional representation of a colander-container vessel in accordance with embodiments of the present invention: and

FIG. 5 is an illustrative orthogonal representation of a colander-container vessel in accordance with embodiments of the present invention.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

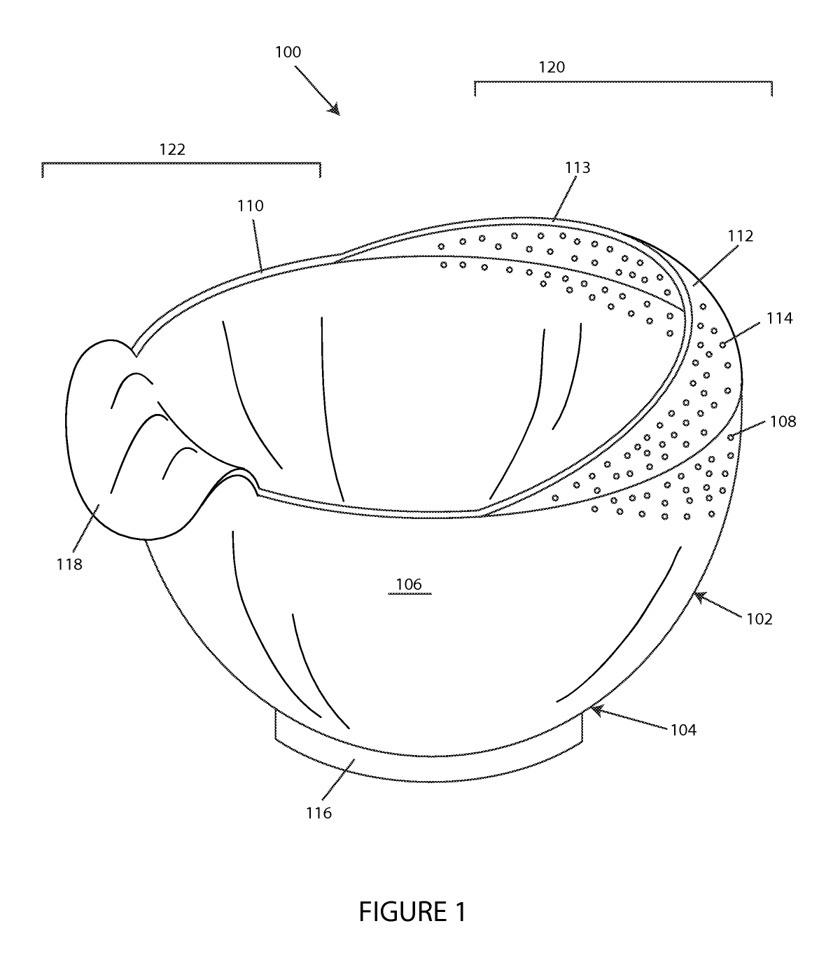

FIG. 1 is an illustrative orthogonal representation of a colander-container vessel 100 in accordance with embodiments of the present invention. As illustrated, colander-container vessel 100 includes bowl 106 that includes bottom surface 104, sidewall surface 102, and lip 110. It may be appreciated that although the howl illustrated is circular and rounded, any number of shapes may be utilized without departing from embodiments provided herein such as, for example, a triangular shape, a square shape, rectangular shape, a circular shape, an ovate shape, and a semi-ovate shape. It may be further appreciated that lip 110 may be flared (not shown) inwardly or outwardly without departing from embodiments provided herein. Further, as illustrated, sidewall surface 102 may include perforations 108 disposed proximate with front portion 120 of lip 110. Perforations may include any number of shapes and sizes without departing from embodiments of the present invention. In some embodiments, perforations along sidewall surfaces may form a spherical lune pattern, which pattern may further enhance colander-container vessel embodiments. In other embodiments, perforations may form a grid pattern, an offset grid pattern, and a random pattern without limitation.

Further as illustrated, colander-container vessel 100 may include retention surface 112 disposed along front portion of lip 120. In embodiments, retention surfaces may extend away and inward from the lip. Furthermore, retention surface 112 may include perforations 114 and retention edge 113, which edge may be a smooth edge, a jagged edge, a scalloped edge, and a contoured edge without departing from embodiments provided herein. As noted above, perforations may include any number of shapes and sizes without departing from embodiments of the present invention. In some embodiments, perforations may form a grid pattern, an offset grid pattern, and a random pattern without limitation. Still further as illustrated, colander-container vessel 100 may include base 116 disposed along bottom surface 104. Base 116 may be configured to maintain colander-container vessel embodiments on substantially planar surfaces in a substantially vertical position. In some embodiments, colander-container vessels may include a second base (not shown) that may be disposed along sidewall surface 102 proximate with handle 118. In these embodiments, the second base may be configured for stabilizing colander-container vessel 100 on a substantially planar surface in a back-tilted position. In some examples, a back-tilted position may allow colander-container vessel embodiments to retain a volume of liquid maximized with respect to perforations 108. In other embodiments, a third base (not shown) may be disposed along sidewall surface 102 proximate with retention surface 112. In these embodiments, the third base may be configured for stabilizing colander-container vessel 100 on a substantially planar surface in a forward-tilted position. In some examples, a forward-tilted position may allow colander-container vessel embodiments to evacuate a volume of liquid from the colander container vessel.

Further as illustrated, colander-container vessel 100 may include handle 118 disposed along back portion 122 of lip 110. In some embodiments, handles may be continuously formed from back portion 122 of lip 110. In other embodiments, colander-container vessels may have no handle (not shown). In still other embodiments, a bowl of colander-container vessels may have a depth-to-width ratio in a range of 1:3.5 to 2:1. In some embodiments, a depth-to-width ratio may be selected from the group consisting of: 1:15, 1:3, 1:2, 1:1, and 2:1 without limitation.

It may be appreciated that colander-container vessels may be manufactured by any variety of methods known in the art without departing from embodiments provided herein. For example, embodiments may be manufactured from any suitable polymeric compound by injection molding, casting, milling, and any other polymeric compound forming processes known in the art without limitation. In some embodiments, colander-container vessels may be manufactured from any suitable metal or metal alloy by die cutting, stamping, casting, welding, forming, and any other metal forming processes known in the art without limitation. In addition, colander-container vessels may be manufactured from any suitable wood by carving, milling, cutting, and any other wood forming processes known in the art without limitation, it may be appreciated that there are a variety of suitable materials with which to manufacture disclosed embodiments, which materials are disclosed by example and without limitation.

### METHODS OF USE

Methods for utilizing colander-container vessel embodiments provided may include the following steps:

a) Providing a colander-container vessel in accordance with embodiments provided herein;

b) Placing solid food stuffs in the colander-container vessel;

c) Filling the colander-container vessel with a liquid;

d) Soaking the solid food stuff for a user defined period;

e) Agitating the solid food stuff; and

f) Straining away the liquid while retaining the solid food stuff in the colander-container vessel.

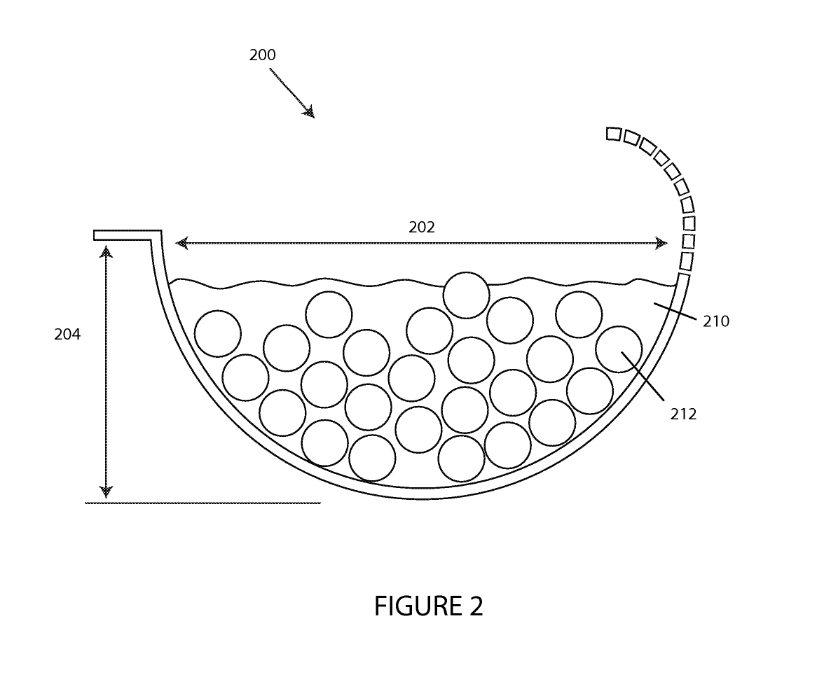

The following illustrations are provided for clarity in understanding method embodiments provided herein. FIG. 2 is an illustrative cross-sectional representation of a colander-container vessel 200 in accordance with embodiments of the present invention. In particular, colander-container vessel 200 is in a vertical position where the howl has width 202 and height 204. As noted above, a base (not shown) may be provided to stabilize colander-container vessel embodiments in this position. Further as noted above, in embodiments, bowls may have a depth-to-width ratio in a range of 1:3.5 to 2:1. In some embodiments, a depth-to-width ratio may be selected from the group consisting of 1:3.5, 1:3, 1:2, 1:1, and 2:1 without limitation. Further, as illustrated, solid food stuff 212 is immersed in liquid 210. As such, FIG. 2 illustrates method embodiments at a step d). It may be noted that in this position, solid food stuffs may be repeatedly agitated in liquids as in a step e). However, in some embodiments, agitating steps may be omitted. In some embodiments, liquids include: an aqueous cleaning solution, a non-aqueous cleaning solution, an aqueous soaking solution, a non-aqueous soaking solution, a non-edible solution, and an edible solution without limitation. In some embodiments, solid food stuffs include: a vegetable, a fruit, a legume, a grain, an animal product, and a plant product without limitation.

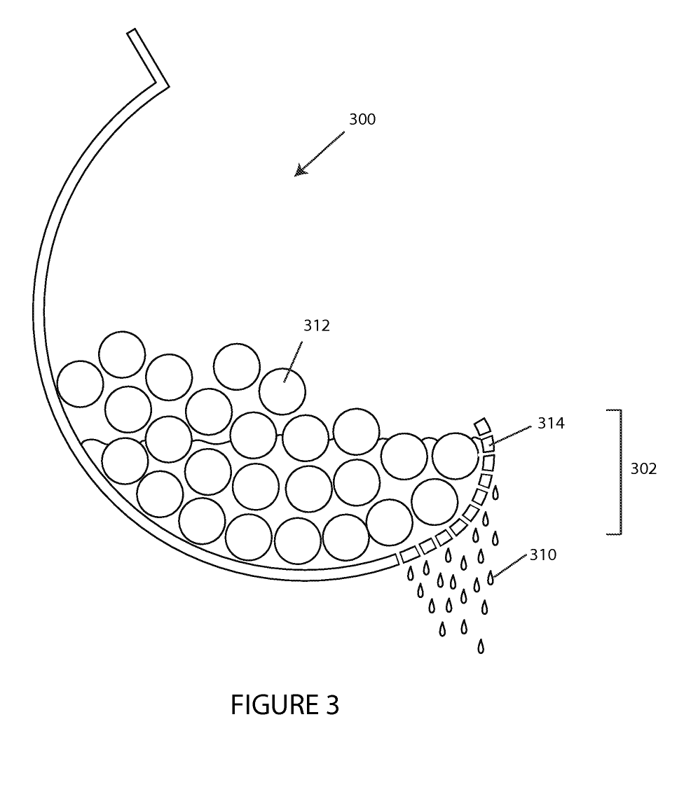

FIG. 3 is an illustrative cross-sectional representation of a colander-container vessel 300 in accordance with embodiments of the present invention. In particular, colander-container vessel 300 is in a forward-tilt position that allows liquid 310 to be strained away through perforations 314 while solid food stuffs 312 are retained by retaining surface 302. As noted above, a base (not shown) may be provided to stabilize colander-container vessel embodiments in this position. FIG. 3 illustrates method embodiments at a step f).

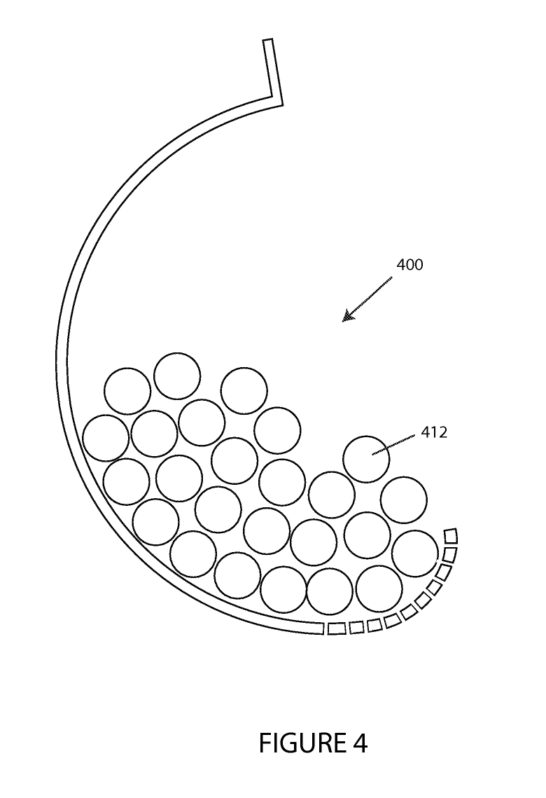

FIG. 4 is an illustrative cross-sectional representation of a colander-container vessel 400 in accordance with embodiments of the present invention. In particular, colander container vessel 400 is in a forward-tilt position that retains solid food stuffs 412 after straining. As may be appreciated, embodiments provide a multi-function tool that allows a user to effectively clean and strain food stuffs during food preparation.

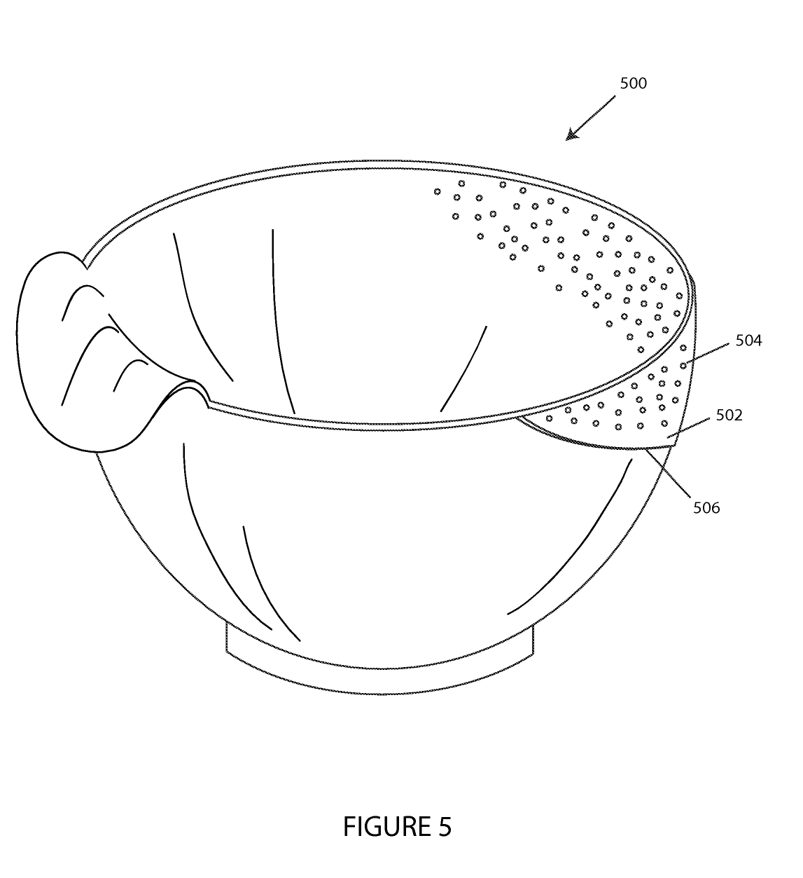

FIG. 5 is an illustrative orthogonal representation of a colander-container vessel 500 in accordance with embodiments of the present invention. As illustrated, colander-container vessel 500 may include retention surface 502 disposed along lip 504. In the illustrated embodiments, retention surface may be manufactured from a flexible material or semi-flexible material such as, for example, silicon rubber, rubber, vinyl, or any other suitable polymeric compound without limitation. In utilizing such material retention surface 502 may be deployed in several positions. For example, a first position may include a position such as illustrated in FIG. 1 (112). In those embodiments, retention surfaces may extend away and inward from the lip. As further illustrated in FIG. 5, in embodiments, retention surface 502 may be folded along outside of bowl 510. It may be seen that folding retention surface allows for solid food stuffs to be more easily inserted and removed from colander-container vessel. Likewise, in some embodiments, a third position may include retention surface folded along inside of bowl without limitation. Furthermore, retention surface 502 may include perforations 504 and retention edge 506, which edge may be a smooth edge, a jagged edge, a scalloped edge, and a contoured edge without departing from embodiments provided herein. As noted above, perforations may include any number of shapes and sizes without departing from embodiments of the present invention. In some embodiments, perforations may form a grid pattern, an offset grid pattern, and a random pattern without limitation. In some embodiments, perforations corresponding with retention surface and perforations corresponding with sidewall surface may be aligned, partially aligned, or non-aligned when retention surface is in a folded position. It may be appreciated that non-aligned perforations may allow colander-container vessel embodiments to function as a bowl without perforation.

While this invention has been described in terms of several embodiments, there are alterations, permutations, and equivalents, which fall within the scope of this invention. It should also be noted that there are many alternative ways of implementing the methods and apparatuses of the present invention. Furthermore, unless explicitly stated, any method embodiments described herein are not constrained to a particular order or sequence. Further, the Abstract is provided herein for convenience and should not be employed to construe or limit the overall invention, which is expressed in the claims. It is therefore intended that the following appended claims be interpreted as including all such alterations, permutations, and equivalents as fall within the true spirit and scope of the present invention.

What is claimed is:

1. A colander-container vessel comprising:
a bowl, the bowl including,
a lip;
a sidewall surface, Wherein the sidewall surface includes a first plurality of perforations disposed proximate with a front portion of the lip, and
a bottom surface; and
a retention surface disposed along the front portion of the lip, wherein the retention surface extends away and inward from the lip.

2. The colander-container of claim 1, further comprising:
a handle disposed along a back portion of the lip,

3. The colander-container of claim 2, wherein the handle is continuously formed from the back portion of the lip.

4. The colander-container of claim 1, wherein the retention surface includes a second plurality of perforations.

5. The colander-container of claim 1, further comprising:
a first base disposed along the bottom surface, wherein the first base is configured for stabilizing the colander-container vessel on a substantially planar surface in a substantially vertical position.

6. The colander-container of claim 1, further comprising:
a second base disposed along the sidewall surface proximate with the handle, wherein the second base is configured for stabilizing the colander-container vessel on a substantially planar surface in a back-tilted position.

7. The colander-container of claim 1, further comprising:
a third base disposed along the sidewall surface proximate with the retention surface, wherein the third base is configured for stabilizing the colander-container vessel on a substantially planar surface in a forward-tilted position.

8. The colander-container of claim 1, wherein the first plurality of perforations form a spherical lune pattern.

9. The colander-container of claim 1, wherein the bowl has a depth-to-width ratio in a range of 1:3.5 to 2:1.

10. The colander-container of claim 9 wherein the bowl has a depth-to-width ratio selected from the group consisting of: 1:3.5, 1:3, 1:2, 1:1, and 2:1.

11. The colander-container of claim 1, wherein the lip is flared.

12. The colander-container of claim 1, Wherein the howl forms a shape selected from the group consisting of: a triangular shape, a square shape, rectangular shape, a circular shape, an ovate shape, and a semi-ovate shape.

13. The colander-container of claim 1, wherein the retention surface further includes a retention edge selected from the group consisting of a smooth edge, a jagged edge, a scalloped edge, and a contoured edge.

14. A colander-container vessel comprising:
a bowl, the bowl including,
a lip,
a sidewall surface, and
a bottom surface; and
a retention surface disposed along the front portion of the lip, wherein the retention surface extends away and inward from the lip, and wherein the retention surface includes a first plurality of perforations.

15. The colander-container of claim 14, further comprising:
a handle disposed along a back portion of the lip.

16. The colander-container of claim 14, wherein the wherein the sidewall surface includes a second plurality of perforations disposed proximate with a front portion of the lip.

17. The colander-container of claim 16, wherein the second plurality of perforations a spherical lune pattern.

18. The colander-container of claim 14, further comprising:
a first base disposed along the bottom surface, wherein the first base is configured for stabilizing the colander-container vessel on a substantially planar surface in a substantially vertical position.

19. The colander-container of claim 14, further comprising:
a second base disposed along the sidewall surface proximate with the handle, wherein the second base is configured for stabilizing the colander-container vessel on a substantially planar surface in a back-tilted position.

20. The colander-container of claim 14, further comprising:
a third base disposed along the sidewall surface proximate with the retention surface, wherein the third base is configured for stabilizing the colander-container vessel on a substantially planar surface in a forward-tilted position.

21. The colander-container of claim 14, wherein the bowl has a depth-to-width ratio in a range of 1:3.5 to 2:1.

22. A method for utilizing a colander-container vessel comprising:
providing the colander-container vessel, wherein the colander-container vessel includes,
a bowl, the bowl including,
a lip,
a sidewall surface, wherein the sidewall surface includes a first plurality of perforations disposed proximate with a front portion of the lip, and
a bottom surface, and
a retention surface disposed along the front portion of the lip, wherein the retention surface extends away and inward from the lip;
placing a solid food stuff in the colander-container vessel;
filling the colander-container vessel with a liquid;
soaking the solid food stuff for a user defined period; and
straining away the liquid while retaining the solid food stuff in the colander-container vessel.

23. The method of claim 22 further comprising:
agitating the solid food stuff before the straining away the liquid.

24. The method of claim 22, wherein the liquid is selected from the group consisting of: an aqueous cleaning solution, a non-aqueous cleaning solution, an aqueous soaking solution, a non-aqueous soaking solution, a non-edible solution, and an edible solution.

25. The method of claim 22, wherein the solid food stuff is selected from the group consisting of a vegetable, a fruit, a legume, a grain, an animal product, and a plant product.
